(19) United States
(12) Patent Application Publication
(10) Pub. No.: US 2020/0061965 A1
(43) Pub. Date: Feb. 27, 2020

(54) SUPPORT COMPRISING ADHESIVE LAYER AND MANUFACTURING METHOD FOR SUPPORT

(71) Applicant: Amorepacific Corporation, Seoul (KR)

(72) Inventors: Haewon JEONG, Yongin-si (KR); Doohyun BAEK, Yongin-si (KR); Seunghwan Yl, Seongnam-si (KR); Kyungho CHOI, Yongin-si (KR)

(73) Assignee: Amorepacific Corporation, Seoul (KR)

(21) Appl. No.: 16/485,987

(22) PCT Filed: Feb. 8, 2018
(86) PCT No.: PCT/KR2018/001699

§ 371 Date: Aug. 14, 2019

(30) Foreign Application Priority Data
Feb. 15, 2017 (KR) 10-2017-0020662

(51) Int. Cl. B32B 5/32; A45D 34/04; B32B 7/12

(52) U.S. Cl. CPC B32B 5/32; B32B 2266/0278; B32B 7/12; A45D 34/04

(57) ABSTRACT

The present invention relates to a support and a manufacturing method for the support. The support for supporting a cosmetic material according to the present invention comprises: a first support having a first bonding surface; a second support having a second bonding surface opposite to the first bonding surface; and an adhesive layer disposed between the first support and the second support and bonding the first bonding surface to the second bonding surface, wherein the adhesive layer is made of at least one of a polyolefin-based material and a polyester-based material.

### TECHNICAL FIELD

The present invention relates to a support comprising an adhesive layer having excellent adhesive strength and a method of manufacturing the support.

### BACKGROUND ART

A conventional low viscosity cosmetic material composition, particularly, a liquid cosmetic composition has been distributed and stored in a state that the liquid cosmetic composition is filled mainly in a vacuum container, a pump container, a glass container or the like. However, these containers have a disadvantage that it is inconvenient to carry them. Therefore, according to an increase in the need to simply do make up or modify one's makeup even when you go out, there has been a demand for an easily carried cosmetic tool.

Recently, a cosmetic tool which allows the cosmetic composition to be conveniently carried by supporting a low viscosity cosmetic composition on a support has been developed. The low viscosity cosmetic composition in such a cosmetic tool may be positioned within pores of a porous support.

On the other hand, a support formed in two or more layers has been used, wherein an adhesive layer for adhesion between respective layers is used in such a support. However, there has been a problem in an existing adhesive layer that adhesive strength is lowered due to specific ingredients, etc. of a cosmetic material.

### DISCLOSURE

### Technical Problem

Therefore, the purpose of the present invention is to provide a support comprising an adhesive layer having excellent adhesive strength and a method of manufacturing the support.

### Technical Solution

The purpose of the present invention is achieved by a support supporting a cosmetic material, the support comprising: a first support having a first bonding surface; a second support having a second bonding surface facing the first bonding surface; and an adhesive layer disposed between the first support and the second support to bond the first bonding surface and the second bonding surface, wherein the adhesive layer is formed of at least one of a polyolefin-based material and a polyester-based material.

The support further comprises a cosmetic material supported on the first support and the second support, and the cosmetic material may comprise an alcohol component.

The first support and the second support may be a polyurethane foam.

The first support and the second support may be a polyether-based polyurethane foam.

The adhesive layer may be formed on a whole surface of the first bonding surface and the second bonding surface.

The adhesive layer may be partially formed on the first bonding surface and the second bonding surface.

The adhesive layer may include low molecular weight fibers.

The purpose of the present invention is achieved by a method of manufacturing a support supporting a cosmetic material, the method comprising the steps of: providing a first support having a first bonding surface and a second support having a second bonding surface; positioning an adhesive sheet between the first bonding surface and the second bonding surface; and melting the adhesive sheet to form an adhesive layer for bonding the first bonding surface and the second bonding surface, wherein the adhesive sheet is formed of at least one of a polyolefin-based material and a polyester-based material.

The method may further comprise the step of supporting the cosmetic material on the first support and the second support after forming the adhesive layer, and the cosmetic material may comprise an alcohol component.

The first support and the second support may be a polyurethane foam.

The adhesive sheet may include low molecular weight fibers.

### Advantageous Effects

According to the present invention, a support comprising an adhesive layer having excellent adhesive strength and a method of manufacturing the support are provided.

### DESCRIPTION OF DRAWINGS

FIG. 1 is a perspective view of a support according to a first embodiment of the present invention.

FIG. 2 is an exploded perspective view of a support according to a second embodiment of the present invention.

FIG. 3 is a cross-sectional view along III-III′ of FIG. 1.

FIG. 4 is a perspective view of a support according to a second embodiment of the present invention.

FIG. 5 is a perspective view of a support according to a third embodiment of the present invention.

FIG. 6 shows an embodiment of a method of manufacturing a support according to the present invention.

FIG. 7 shows the other embodiment of a method of manufacturing a support according to the present invention.

### MODE FOR INVENTION

Hereafter, the present invention will be described more in detail with reference to the drawings.

However, the accompanying drawings are only an example shown for describing in more detail a technical spirit of the present invention and therefore, the technical spirit of the present invention is not limited to the accompanying drawings.

A “support” in the present specification means a material which can support a cosmetic material, and can be expressed also as “a medium” or “a carrier”. Further, the “support” represent both a material which has the cosmetic material supported therein and a material which does not have the cosmetic material supported therein.

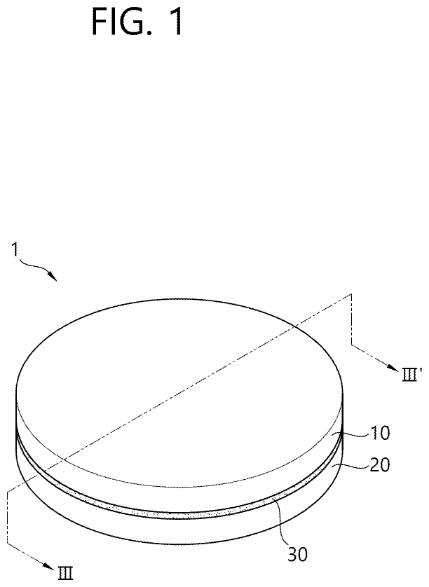

A support according to a first embodiment of the present invention is described by referring to FIG. 1 to FIG. 3.

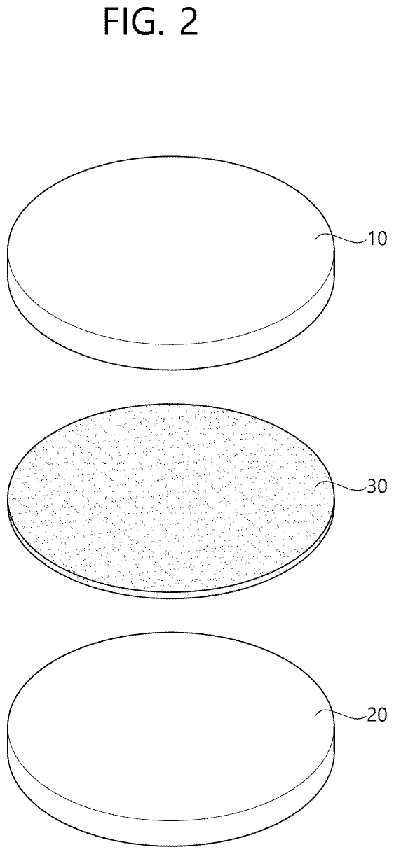

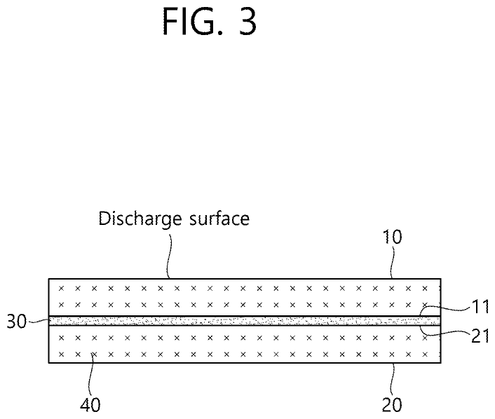

FIG. 1 is a perspective view of a support according to a first embodiment of the present invention, FIG. 2 is an exploded perspective view of a support according to a second embodiment of the present invention, and FIG. 3 is a cross-sectional view along III-III′ of FIG. 1.

A support 1 includes a first support 10, a second support 20, an adhesive layer 30, and a cosmetic material 40. The support 1 is formed in an overally thick disk shape. The first support 10 has a discharge surface for discharging the cosmetic material 40.

The first support 10 and the second support 20 have a similar shape, and thicknesses of the first support 10 and the second support 20 may be the same as or different from each other. The cosmetic material 40 is supported on the first support 10 and the second support 20.

The first bonding surface 11 of the first support 10 and the second bonding surface 21 of the second support 20 are bonded by the adhesive layer 30. The first support 10 and the second support 20 are bonded to each other by the adhesive layer 30.

The adhesive layer 30 is formed all over the first bonding surface 11 and the second bonding surface 21.

The first support 10 and the second support 20 may be formed of materials that are the same as or different from each other.

The first support 10 and the second support 20 may be formed of a porous material. For example, a synthetic porous material may be a foam. Although examples of the foam may include one or more materials selected from the group consisting of NBR (acrylonitrile butadiene rubber), BR (butadiene rubber), SBR (styrene butadiene rubber), NR (natural rubber), wet-type urethane, dry-type urethane, polyether, polyester, polyvinyl chloride, polyethylene, EVA (ethylene vinyl acetate), latex, silicone, SIS (styrene isoprene styrene), SEBS (styrene ethylene butylene styrene), PVA (polyvinyl alcohol), silicone elastomeric materials, nitrile rubber, butyl rubber, and neoprene, the foam is not limited thereto. The foam my be formed by a dry-type foaming method or a wet-type foaming method, and the foam may contain fibers. Further, examples of natural porous material may include loofah, Konjac(elephant foot), sponge, cellulose, bio cellulose, and scoria.

Further, the first support 10 and the second support 20 may be made of a synthetic or natural fiber. Although the natural fiber is not limited thereto, the natural fiber may be made of at least one of cellulose, natural pulp, loofah, ramie fabric, ramie (plant), ayate (a rough fabric of agave or palm tree), algae, bamboo, sisal, sisal terry (a fabric woven with sisal), Konjac, TENCEL™ fiber fabric, (Tencell fibers with a natural antibacterial function made of eucalyptus tree), cotten felt, Tencel cotton and abaca fiber, or may be formed by comprising at least one thereof.

Although the synthetic fiber is not limited thereto, the synthetic fiber may be formed of at least one of nylon, acetate fiber, nylon nonwoven fabric, Cashmilon fiber (a synthetic fiber, i.e., an acryl fiber comprising an acrylonitrile (CH₂═CH—CN) fiber as a main component), Comfort fiber, polytrimethylene terephthalate fiber, polyethylene, polypropylene, polyacrylate, polyacetate, polyolefin, PLA (polylactic acid), and polylactic acid-based composite fiber (environmentally biodegradable).

At least one of the first support 10 and the second support 20 may have a porous material, a WEB structure, a crimping structure, a foaming and WEB structure, or a foaming and crimping structure.

The first support 10 and the second support 20 may have the same cosmetic material 40 supported thereon, or may have cosmetic materials 40 different from each other supported thereon. The cosmetic material 40 may be an emulsion-type composition, specifically, a water-in-oil-in-water (W/O/W) type, oil-in-water-in-oil (O/W/O) type, water-in-oil (W/O) type or oil-in-water (O/W) type composition, a dispersion type composition, or specifically an oil-dispersed or water-dispersed composition.

At least one of the first support 10 and the second support 20 may be a polyether-based polyurethane foam. Both the first support 10 and the second support 20 may be the polyurethane foam and may have different pore sizes.

A multilayer structure of the support 1 is used to enable a uniform amount of the cosmetic material 40 to be discharged by adjusting a discharge amount of the cosmetic material 40 or to soften the cosmetic material by changing a discharge path of the cosmetic material 40.

Further, the multilayer structure of the support 1 may be used to prevent a phenomenon that the support 1 is darkened by shadow of pores by using an upper layer having a small pore size. In this case, since a lower layer has a larger pore size than the upper layer, the lower layer has an excellent cosmetic material supporting capability, and may be thicker than the upper layer.

For example, the cosmetic material 40 may be a liquid composition or a solid composition, and the cosmetic material 40 may include a powder composition such as a powder when the cosmetic material 40 is the solid composition. Further, for example, although the cosmetic composition may be formulated into a makeup primer composition, a makeup base composition, a foundation composition, a concealer composition, a lip composition, a lip liner composition, an eyebrow composition, an eye shadow composition, an eyeliner composition, a blusher composition, a ultraviolet blocking agent composition, or a skin care composition, the cosmetic composition is not limited thereto.

The cosmetic material 40 may include alcohol to give a cooling sensation. Content of a preservative agent may be reduced when the cosmetic material 40 includes alcohol. Although the alcohol is not limited thereto, the alcohol may be ethanol. The alcohol may be contained in the cosmetic material 40 in an amount of 1 to 15 wt %, 3 to 12 wt %, or 5 to 10 wt %.

The adhesive layer 30 is formed of components stable to alcohol, and although the adhesive layer 30 is not limited thereto, the adhesive layer 30 may be formed of a polyolefin-based material and a polyester-based material. Specifically, the adhesive layer 30 may be formed by melting a web type adhesive made of the polyolefin-based or polyester-based material, and the web type adhesive has a sheet shape and may be obtained by spinning the adhesive in the form of a net. Further, the adhesive layer 30 may include low molecular weight fibers.

Since fine through holes are formed in the adhesive layer 30, the cosmetic material 40 can be moved between the first support 10 and the second support 20.

According to a first embodiment, since the adhesive layer 30 is formed of the components stable to alcohol, bonding of the first support 10 and the second support 20 is stably performed although the cosmetic material 40 including alcohol is used.

In other embodiments, shape of the support 1 may be modified into various shapes including a rectangular plate and the like, and the support 1 may be formed in three layers or more.

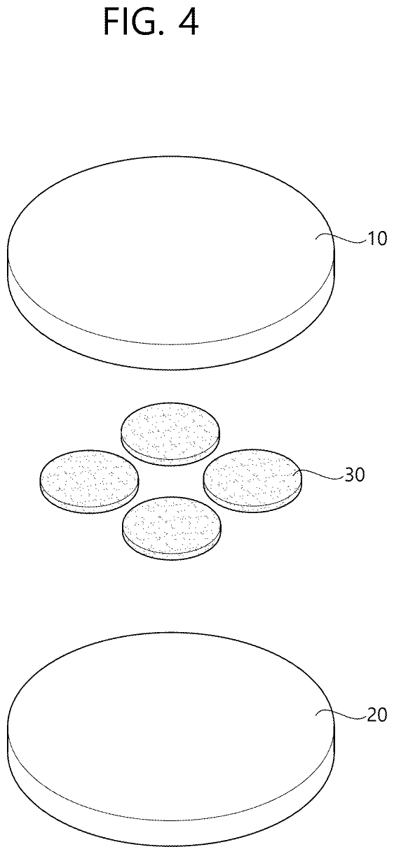

FIG. 4 is a perspective view of a support according to a second embodiment of the present invention.

The adhesive layer 30 is scattering distributed, and the first bonding surface 11 and the second bonding surface 21 are partially bonded by the adhesive layer 30.

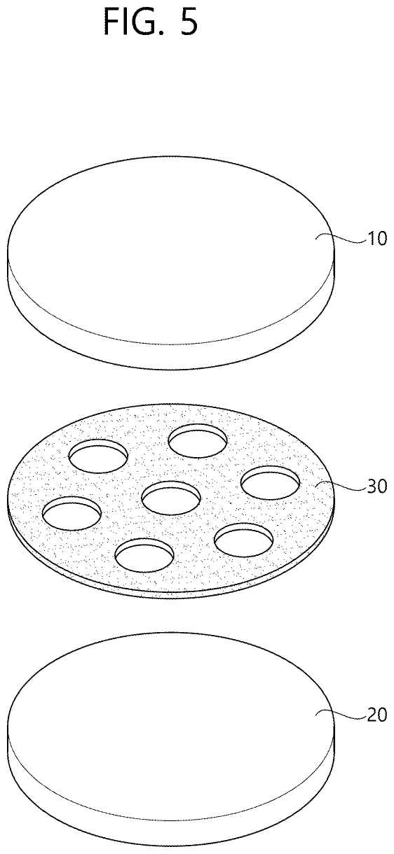

FIG. 5 is a perspective view of a support according to a third embodiment of the present invention.

The adhesive layer 30 has a partially hollow portion formed therein, and the first bonding surface 11 and the second bonding surface 21 are partially bonded by the adhesive layer 30.

According to a second embodiment and a third embodiment, the first support 10 and the second support 20 have a portion which are directly brought into contact with each other without the adhesive layer 30 in a state that the first support 10 and the second support 20 are bonded to each other. Accordingly, the cosmetic material 40 can be smoothly moved between the first support 10 and the second support 20.

Hereinafter, a method of manufacturing a support according to the present invention will be described.

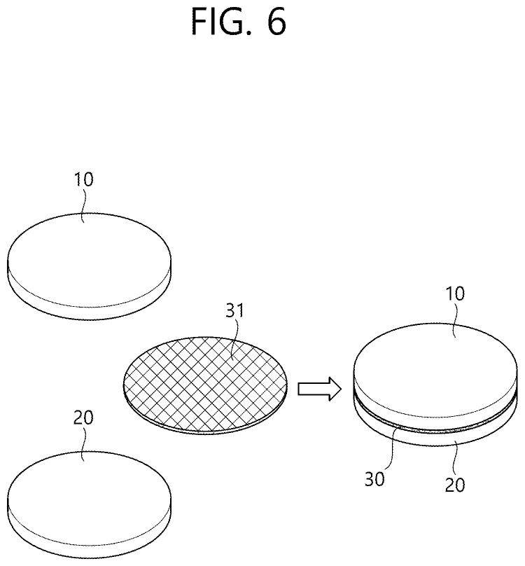

FIG. 6 shows an embodiment of a method of manufacturing a support according to the present invention.

A first support 10, a second support 20 and an adhesive sheet 31 are prepared. The adhesive sheet 31 is made of a polyolefin-based or polyester-based material and has a thin sheet shape. The adhesive sheet 31 may be a hot melt adhesive in the form of a nonwoven fabric obtained by spinning low molecular weight fibers melted at low temperatures into a net shape, and may have a web shape. The adhesive sheet 31 may exhibit bonding performance at a relatively low temperature. For example, the adhesive sheet 31 may have a DSC (softening point) of 105° C. or less, 110° C. or less, or 120° C. or less, more specifically, 80° C. to 105° C., 80° C. to 110° C., or 80° C. to 120° C.

The adhesive sheet 31 is positioned between the first support 10 and the second support 20, and the adhesive sheet 31 is melted. A melting process can be performed using hot air, and a bonding process is carried out while the adhesive sheet 31 is being melted. The adhesive sheet 31 is melted to form the adhesive layer 30, and bonds the first support 10 and the second support 20.

After bonding the first support 10 and the second support 20, a cosmetic material is supported.

A pressing process may be performed during the melting process or after the melting process in order to ensure the bonding process.

A bonding process using the adhesive sheet 31 can be performed using an electric fusing press, a heated roll, hot air, radiant heat, steam press, etc. The bonding process may be performed at a thermal bonding temperature of 105° C. to 125° C.

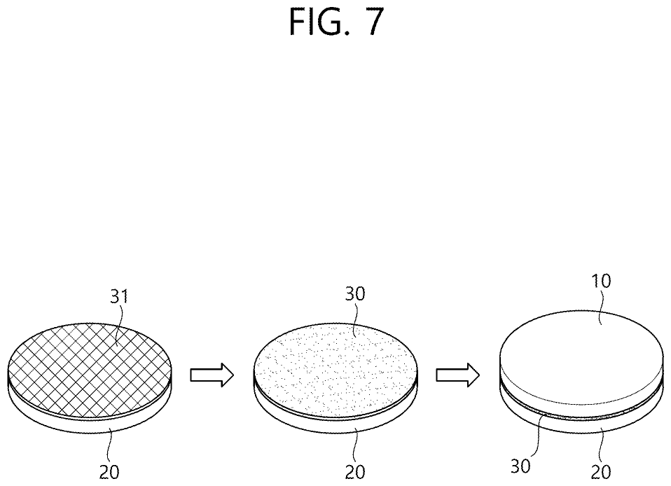

FIG. 7 shows the other embodiment of a method of manufacturing a support according to the present invention.

The adhesive layer 30 is formed by positioning the adhesive sheet 31 on the second support 20 and melting the adhesive sheet 31 positioned on the second support 20. Before the adhesive layer 30 is hardened, the first support 10 is positioned on the adhesive layer 30, and the first support 10 and the second support 20 are bonded.

The above-described method may be diversely modified. Shape and distribution of the adhesive sheet 31 may be diversely modified, and shape of the adhesive layer 30 is also varied accordingly. Further, the adhesive layer 30 may be formed using various types of adhesives including a spherical adhesive and a liquid adhesive without using the adhesive sheet 31.

Hereinafter, the present invention will be described more in detail through experimental examples.

A polyurethane foam with a thickness of 1 mm was used as the first support 10. The polyurethane foam is a wet-type urethane foam comprising polyether and polyester at a ratio of 5:5 and having reinforced chemical resistance by containing a polycarbonate diol.

A polyether-based polyurethane foam with a thickness of 8 mm was used as the second support 20.

In Example, the adhesive layer 30 was formed using a polyester-based low temperature reactive adhesive sheet 31. In Comparative Example, an isocyanate-based adhesive was used.

The adhesive layer 30 was formed all over the first bonding surface 11 and the second bonding surface 21, and the adhesive sheet 31 was melted using hot air. After performing a melting process, pressing, cleaning and drying processes were performed.

After manufacturing a support, separation strength testing processes with respect to alcohol were carried out on the support. Total four alcohol solutions including an 100% ethanol solution, a 15% ethanol solution, a 10% ethanol solution and a 5% ethanol solution were used.

The test processes comprises: 1) leaving alone a support within an alcohol solution contained in a 50° C. thermostat for 7 days; 2) checking whether the support had been separated or not using tweezers; 3) measuring a separation strength value in a state that the content was removed as much as 90% or more after the cleaning process when the support had not been separated using the tweezers (measuring the separation strength value using a push-pull gauge, fixing and pulling a top surface of the support using scissors having tongs or push-pull tongs, and fixing a bottom surface of the support with a jig or hand); and 4) checking whether the support had been separated or not when pulling the support using a force of 0.4 kg·f measured by the push-pull gauge (the push-pull gauge had a speed of 10 mm/sec).

Experimental results are as represented in the following Table 1.

TABLE 1

| | EtOH 100% | EtOH 15% | EtOH 10% | EtOH 5% |
|---|---|---|---|---|
| Comparative | 0 kg · f | 0.1 kg · f | 0.1 kg · f | 0.2 kg · f |
| Example | | | | |
| Example | 0.4 kg · f | 0.4 kg · f | 0.6 kg · f | 0.8 kg · f |

As shown in the experimental results of Comparative Example, the support is separated using the tweezers at the 100% ethanol solution. A low separation strength value is obtained although the support is not separated using the tweezers when an ethanol content is low.

Meanwhile, the experimental results of Example show that the support is stably bonded since a high separation strength value is shown even in the 100% ethanol solution.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A support supporting a cosmetic material, the support comprising:
a first support having a first bonding surface;
a second support having a second bonding surface facing the first bonding surface; and
an adhesive layer disposed between the first support and the second support to bond the first bonding surface and the second bonding surface, wherein the adhesive layer is formed of at least one of a polyolefin-based material and a polyester-based material.

2. The support of claim 1, further comprising a cosmetic material supported on the first support and the second support, wherein the cosmetic material comprises an alcohol component.

3. The support of claim 2, wherein the first support and the second support are a polyurethane foam.

4. The support of claim 3, wherein the first support and the second support are a polyether-based polyurethane foam.

5. The support of claim 2, wherein the adhesive layer is formed on whole surface of the first bonding surface and the second bonding surface.

6. The support of claim 2, wherein the adhesive layer is partially formed on the first bonding surface and the second bonding surface.

7. The support of claim 2, wherein the adhesive layer includes low molecular weight fibers.

8. A method of manufacturing a support supporting a cosmetic material, the method comprising the steps of:
providing a first support having a first bonding surface and a second support having a second bonding surface;
positioning an adhesive sheet between the first bonding surface and the second bonding surface; and
melting the adhesive sheet to form an adhesive layer for bonding the first bonding surface and the second bonding surface, wherein the adhesive sheet is formed of at least one of a polyolefin-based material and a polyester-based material.

9. The method of claim 8, further comprising the step of supporting the cosmetic material on the first support and the second support after forming the adhesive layer, wherein the cosmetic material comprises an alcohol component.

10. The method of claim 9, wherein the first support and the second support are a polyurethane foam.

11. The method of claim 9, wherein the adhesive sheet includes low molecular weight fibers.
